(19) United States
(12) Patent Application Publication
(10) Pub. No.: US 2014/0304176 A1
(43) Pub. Date: Oct. 9, 2014

(54) SYSTEM AND METHOD FOR RISK ASSESSMENT OF INTANGIBLE PROPERTY

(71) Applicants: Rory J. Radding, New York, NY (US); John W. Olivo, JR., La Jolla, CA (US); Thomas J. Maiorino, Mount Laurel, NJ (US); Jason Mackey, Dallas, TX (US)

(72) Inventors: Rory J. Radding, New York, NY (US); John W. Olivo, JR., La Jolla, CA (US); Thomas J. Maiorino, Mount Laurel, NJ (US); Jason Mackey, Dallas, TX (US)

(21) Appl. No.: 14/217,031

(22) Filed: Mar. 17, 2014

Related U.S. Application Data
(60) Provisional application No. 61/852,193, filed on Mar. 15, 2013.

(51) Int. Cl. G06Q 50/18; G06Q 10/10

(52) U.S. Cl. CPC G06Q 50/184; G06Q 10/10
USPC 705/310

(57) ABSTRACT

A system and method which objectively assesses the risks encountered by, and provides greater assurance among, purchasers, investors, insurers and financers of intangible property is disclosed. Such intangible assets may include patents, trademarks, copyrights and other forms of intangible assets. The system and method provides greater assurance that such intangibles have clear title or are otherwise unencumbered, are not the subject of litigation or other proceedings, and/or are valid and enforceable. The system and method of the invention may comprise: (i) a database which comprises data and other information related to the risk assessment of the intangible property; (ii) a search engine which searches and retrieves from the database data and other information related to the risk assessment of the intangible property; (iii) an assurance ranking generator which utilizes objective assessment criteria to determine accuracies and inaccuracies in the information and data, and generates an assurance ranking associated with the intangible property being assessed for risk. In addition, the system and method of the instant invention may further employ real-time and/or reactive computing systems.

### CROSS REFERENCE TO RELATED APPLICATION

This application claims priority to U.S. Provisional Patent Application Ser. No. 61/852,193, filed Mar. 15, 2013, entitled “System and Method for Risk Assessment of Intangible Property,” the entirety of which is incorporated herein by reference.

### FIELD OF THE INVENTION

This invention is directed to a system and method for risk assessment of intangible assets. More specifically, this invention is directed to a system and method for providing an assessment of, and understanding the risks encountered in, transactions involving intellectual property such as patents, trademarks, copyrights and other intangibles. The invention is further directed to a system and method for raising the assurance among purchasers, investors, insurers and financers of intangible property that such intangibles have clear title, are unencumbered, and/or are valid and enforceable.

### BACKGROUND OF THE INVENTION

Traditionally, assessing and assuring the risks in the purchase of an asset often involves extensive and costly due diligence. Such due diligence may include manual and semi-automated searching of various and disparate records, databases and other sources. This problem is difficult enough to solve when the property is tangible, such as in the cases of real estate and personal property. However, the problem is further compounded when the asset is related to intangible property, such as patents, trademarks, and copyrights.

It is increasingly common that such intangible assets comprise the subject matter of, or are used as the collateral in, significant business transactions. Moreover, such intangibles often comprise a significant portion of the assets of a business and are subject to litigation involving the validity and/or infringement of the intangible.

Inasmuch as intangibles are gaining increasing importance in both domestic and international transactions, as well as in litigation, it is becoming increasingly important to provide parties to such transactions or who may be affected by litigation with more reliable, accurate, and cost effective information through the due diligence process. Such information may include, for example, verification of the chain of title of the asset, identification of the encumbrances on the asset, the validity and enforceability of the asset, as well as past and pending litigation which involves or otherwise impacts the asset. As the certainty among purchasers, investors, insurers and financers in the transferability and marketability of such assets increases, the market value of the asset should also increase, and should lead to more litigation being averted, transactions being completed, and investments being made.

Thus, there exists a need for a system and method of assessing the risks in the investment and/or purchase of an asset. There also exists the need for a system and method which provides greater assurance among purchasers, investors, insurers and financers of intangible property that such intangibles have clear title, are unencumbered, and/or are valid and enforceable. The need also exists to provide a system and method for insuring against the uncertainties in the purchase of and investment in intangibles.

In addition, there exists a need for a system and method of improving the speed, accuracy and reliability of information delivered through the due diligence process so that decision makers can make better risk assessments, and more informed decisions. In this regard, there also exists the need for a system and method which delivers the results of such due diligence in real-time.

### SUMMARY OF THE INVENTION

The present invention relates to a system and method which objectively assesses the risks encountered by, and provides greater assurance among, purchasers, investors, insurers and financers of intangible property. Such intangible assets may include patents, trademarks, copyrights and other forms of intangible assets. The system and method of the present invention provides greater assurance that such intangibles have clear title, are otherwise unencumbered, are not the subject of litigation or other proceedings, and/or are valid and enforceable.

The system and method of the instant invention may comprise one or more of: (i) a database which comprises data and other information related to the risk assessment of the intangible property; (ii) a search engine which searches and retrieves from the database data and other information related to the risk assessment of the intangible property; (iii) an assurance ranking generator which utilizes objective assessment criteria to determine accuracies and inaccuracies in the information and data and generates an assurance ranking associated with the intangible property being assessed for risk.

The assurance ranking generator of the system and method of the instant invention may also comprise one or more of: (i) a data reliability analyzer which assesses the accuracy of the data and information; (ii) an assurance score analyzer which assigns an assurance score to the intangible property; and (iii) an assurance ranking comparator which compares the assurance score against an assurance ranking scale to generate an assurance ranking associated with the intangible property.

The system and method of the instant invention may also comprise a system and method for developing risk assessment models for use with assessing the risk associated with the valuation, insurability, or collateralization of intangible assets. In this embodiment, the system and method may comprise a processor having an input for receiving predetermined parameters, selected from the group comprising algorithms, protocols, and rules which are relevant to the analysis of the accuracy of data and other information associated with the asset being analyzed. In this regard, the processor may be programmed to:
(i) execute a predetermined software program to implement risk assessment analysis models selected from the group comprising: data comparison and verification, known risk factor analysis, Monte Carlo numerical analysis, and linear programming methodologies to determine the likelihood of error in the data being analyzed;
(ii) generate an assurance score based upon said likelihood of error in the data being analyzed; and
(iii) generate an assurance ranking based upon a comparison of said assurance score against a predetermined assurance ranking scale.

In addition, the system and method of the instant invention may further employ real-time or reactive computing systems and methodologies to enable due diligence to be conducted such that results generated by the system and method may be returned to the user during a single interactive computing session.

### BRIEF DESCRIPTION OF THE DRAWINGS

Understanding of the present invention will be facilitated by consideration of the following detailed description of the embodiments of the present invention taken in conjunction with the accompanying drawings, in which like numerals refer to like parts, and wherein:

FIG. 1 depicts a schematic illustrating one embodiment of the risk assessment system and method of the present invention; and

FIG. 2 depicts a schematic illustrating another embodiment of the risk assessment system and method of the present invention.

### DETAILED DESCRIPTION OF THE EMBODIMENTS

It is to be understood that the figures, images and descriptions of the present invention have been simplified to illustrate elements that are relevant for a clear understanding of the present invention, while eliminating, for the purposes of clarity, many other elements which may be found in the present invention. Those of ordinary skill in the pertinent art will recognize that other elements are desirable and/or required in order to implement the present invention. However, because such elements are well known in the art, and because such elements do not facilitate a better understanding of the present invention, a discussion of such elements is not provided herein.

Reference will now be made in detail to several embodiments of the present invention, examples of which are also illustrated in the accompanying drawings.

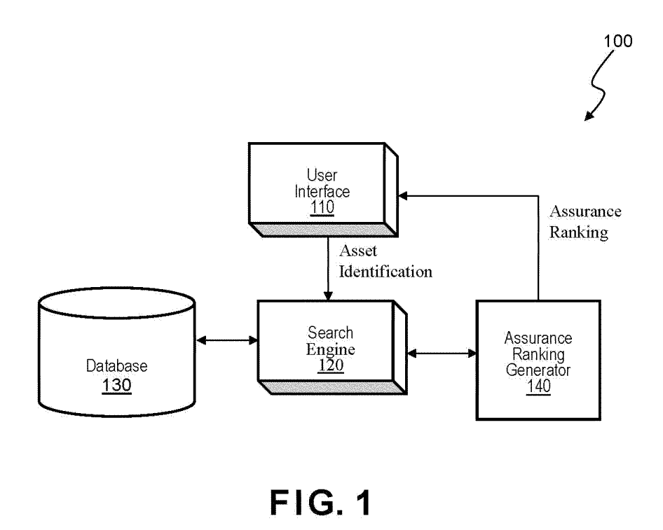

Turning now to FIG. 1, there is shown a schematic illustrating an embodiment of Risk Assessment System 100 of the present invention. In this embodiment, System 100 comprises User Interface 110, Search Engine 120, Database 130, and Assurance Ranking Generator 140.

In the embodiment shown in FIG. 1, User Interface 110 enables users of System 100 to input information and data into System 100, and request and receive information and data from System 100. User Interface 110 may comprise a computer comprising one or more input devices such as a keyboard and/or a mouse, as well as a display which enables a user to transmit information and data to, receive information and data from, and/or otherwise interact with System 100. Information and data input through User Interface 110 may include descriptive information concerning the intangible asset to be analyzed, such as for example a patent number, a trademark or copyright registration number, a patent or trademark application number, an applicant's or registrant's name or names, an assignor's or assignee's name and/or a search request.

Users of System 100 may also request and receive information, data and reports through and/or generated by User Interface 110. Such information, data and/or reports may include the identification of past and/or current owners, licensor and/or licensees; a report of the chain of title of the intangible property being analyzed by System 100; a report of security interests or other liens against the property; a report of the release of security interests or other liens against the property; and/or a report of pending litigation, reexaminations, reissues, post grant proceedings, trademark oppositions and cancellations; and/or other adversarial proceedings involving the intangible property being analyzed by System 100. In addition, reports containing the results of the risk assessment analyses conducted may also be generated by System 100.

Search Engine 120 is capable of receiving and processing, via a processor or other computerized device, commands through User Interface 110 such as search requests related to the intangible asset being analyzed. Search Engine 120 processes the command from User Interface 110 and, when necessary, retrieves information and data from Database 130. Search Engine 120 is capable of mining relevant information and data, and which data may be available through any public or non-public source, such as Database 130.

Database 130 may comprise one or more databases, or other data storage devices, which contain information related to the commands received and/or the asset being analyzed. Information contained in Database 130 may also include, but not be limited to: chain of title information; security interests; releases, or other liens against the property; historical risk analyses conducted by System 100 or elsewhere; parameters, algorithms, protocols and/or rules which are relevant to the analysis of the property being analyzed; pending litigation, reexaminations, reissues, post grant proceedings, trademark oppositions and cancellations; and/or other adversarial proceedings involving the intangible property being analyzed. In certain embodiments of the invention, Database 130 may comprise: the United States and foreign patent and trademark office databases; federal, state and local databases, including UCC filings and other public documents; United States and foreign court and administrative agency databases; technical and business databases; non-public data and information; and/or other sources of information relevant to the analysis of property being analyzed.

Assurance Ranking Generator 140 is capable of processing, via a processor or other computerized device, the information and data received from Search Engine 130 and processing and assessing the reliability of the information and data received through Search Engine 120. Such assessment may include comparison of data received from one source to similar data received from an independent source, utilizing known rates of data errors and omissions associated with particular data sources, and/or utilizing statistical models to determine the likelihood of error in the data being analyzed, such as Monte Carlo simulation, linear programming methodologies, or other statistical and/or objective risk analysis methods.

Once Assurance Ranking Generator 140 assesses the accuracy of the data being analyzed, the accuracy of the data is ranked against an established reliability scale to generate an assurance ranking of the information received. Such an assurance ranking may then be utilized by purchasers, investors, insurers and financers interested in the property being analyzed to determine, for example, insurance premium rates, purchase prices, licensing royalty rates, whether investments will be made, and/or financing will be granted.

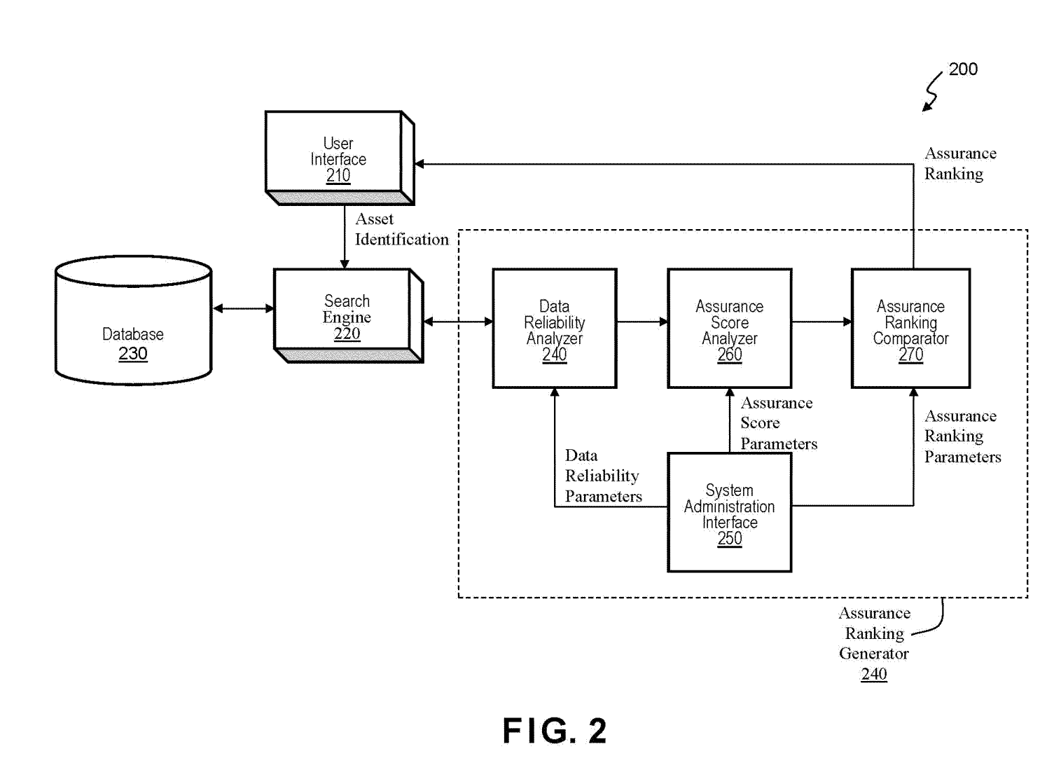

Turning now to FIG. 2, there is shown a schematic of Risk Assessment System 200 illustrating yet another embodiment of the instant invention. In this embodiment, System 200 comprises User Interface 210, Search Engine 220, Database 230, and Assurance Ranking Generator 240. Each of User Interface 210, Search Engine 220, Database 230, and Assurance Ranking Generator 240 comprise at least the functionality and capability of User Interface 110, Search Engine 120, Database 130, and Assurance Ranking Generator 140, respectively, described in connection with the embodiment depicted in FIG. 1. In yet another embodiment of the invention, System 200 may further comprise System Administration Interface 250.

System 200 further comprises Assurance Ranking Generator 240 which may include a set of predetermined parameters, algorithms, protocols and/or rules which are relevant to the analysis of the accuracy of the data being analyzed. Such parameters, algorithms, protocols and/or rules may be established and modified by a System Administrator of System 200. Data and information received from Search Engine 220 may then be analyzed by Assurance Ranking Generator 240 relative to the predetermined parameters, algorithms, protocols and/or rules.

In one embodiment of System 200, Assurance Ranking Generator 240 may comprise Data Reliability Analyzer 240, Assurance Score Analyzer 260, Assurance Ranking Generator 270, and System Administration Interface 250.

Data Reliability Analyzer 240 processes and analyzes data and information received from Search Engine 220. In one embodiment of the invention, Data Reliability Analyzer 240 assesses the reliability, accuracy, and completeness of the data received from Search Engine 220 utilizing objective methodologies. Such methodologies may include, for example, comparison of data contained in one database to equivalent data contained in an independent database, Monte Carlo simulation, linear programming methodologies, or other statistical and/or objective risk analysis methods. The results of the analysis conducted by Data Reliability Analyzer 240 are transmitted to, or retrieved by, Assurance Score Analyzer 260.

Assurance Score Analyzer 260 assigns a positive or negative score to the property being analyzed based upon the results of the data reliability analysis conducted by Data Reliability Analyzer 240. In one embodiment, a positive Assurance Score is assigned to the property if the results of the analysis conducted by Data Reliability Analyzer 240 confirm the reliability of the data. Conversely, a negative Assurance Score is assigned to the property if the results of the analysis conducted by Data Reliability Analyzer 240 show a discrepancy, inconsistency or lack of reliability in the data being analyzed. The Assurance Score may be generated based upon preset Assurance Score parameters, algorithms, protocols and/or rules which are relevant to some or all of the aspects of the information, data and/or property being analyzed. The Assurance Score for the property or an aspect feature or characteristic of the property generated by Assurance Score Analyzer 260 is transmitted to, or retrieved by, Assurance Ranking Comparator 270.

Assurance Ranking Comparator 270 compares the Assurance Score generated by Assurance Score Analyzer 260 against one or more established Assurance Ranking Scales to generate an Assurance Ranking for the property. The Assurance Ranking Scales may be generated based upon preset Assurance Score parameters, algorithms, protocols and/or rules which are relevant to some or all of the aspects of the property being analyzed. In certain embodiments of the invention, the Assurance Ranking Scales are related to risk levels which impact intangible property valuation, licensing royalties, insurance premiums, loan rates, past and present litigation, and/or financial lending decisions.

Administrators may also access, maintain, control, and otherwise administer to System 100 through System Administration Interface 250. Such administrative functions may include, but are not limited to setting and maintaining Assurance Ranking Scales, as well Data Reliability, Assurance Score, and/or Assurance Ranking parameters, algorithms, protocols and/or rules which are relevant to some or all of the aspects of the property being analyzed.

Once generated, the Assurance Ranking of the property or an aspect feature or characteristic of the property generated by Assurance Ranking Comparator 270 is delivered to, or retrieved by, User Interface 210.

It should also be noted that the functionality and sophistication of present day computer systems and software enable the present invention to account for variations in the reliability of available data from available data sources, where manual methodologies would otherwise be impracticable or impossible. For example, it is known that there are errors and omissions in the data contained in the United States Patent and Trademark Office databases, as well as among various federal, state and local records and databases which may contain information which is relevant to the various forms of intangible property to be analyzed. Thus, implementing present day computer processing systems enables users of the instant invention to assess risks associated with intangible property with speed and accuracy not previously available.

In this regard, the various embodiments of the system and method of the instant invention may further comprise a real-time or reactive computing system where results generated by the system and method may be returned to the user during a single interactive computing session.

Thus, the various embodiments of the system and method of the instant invention may further comprise one or more central processing units or other computerized devices, such as servers, through which content and other information, such as assignment and ownership information, liens, security interests, licenses, past and present litigation and other information which involves or otherwise impacts the asset, may be accessed and utilized. The computerized systems used in connection with the present invention may also be configured to adjust metric parameters (such as Data Reliability, Assurance Score and Assurance Ranking Parameters), as well as methodologies used to assess risk (such as linear programming and Monte Carlo simulations).

Users and Administrators may also employ handheld units to access, use, maintain, and otherwise manage the system of this invention. Information input to or generated by the system of this invention may be readily accessible to a user of the handheld in text, graphical, visual, video, animated, audio, and/or other formats. The system of this invention may further comprise an internet based system having a portal through which users and administrators of the system of the invention may access the content, data and other information contained on the server and/or handhelds, and/or generally access the user and/or administrative functions of the system.

Turning now to another embodiment of the instant invention, System 200 may be configured to confirm the accuracy of the name of the current assignee of a United States Patent for the purpose of obtaining title insurance on the patent. In this embodiment, a user of System 200 inputs the Patent Number of the United States Patent into System 200 through User Interface 210, and requests, through User Interface 210, that System 200 verify that the assignee named on the face of the patent is in fact the current owner of the patent.

In response to the query, Search Engine 220 accesses the United States Patent and Trademark Office's issued patent database 230, and retrieves the name of the assignee which appears on the face of the issued patent identified by the user. The assignee name retrieved from issued patent database 230 is then sent to or retrieved by Data Reliability Analyzer 240. Search Engine 220 also accesses the United States Patent and Trademark Office's recorded assignments database 230, and retrieves the name of the last recorded assignee which appears in recorded assignments database 230. The assignee name retrieved from recorded assignments database 230 is also transmitted to or retrieved by Data Reliability Analyzer 240. For the purposes of this application, if it is stated that data or other information is sent or otherwise transmitted from a first source to a second source, it should be understood that such data may also be retrieved or otherwise accessed by the second source from the first source, as the case may be, unless the context suggests otherwise.

Data Reliability Analyzer 240 then compares the names of the assignees retrieved from each database. The results of the comparison by Data Reliability Analyzer 240 are transmitted to Assurance Score Analyzer 260, where the result is assigned an Assurance Score based upon the results of the comparison and/or other Data Reliability Parameters applied by Data Reliability Analyzer 240. In the instant embodiment, a higher Assurance Score would be assigned to the patent if the assignee names retrieved from the database matched, where a lower Assurance Score would be assigned to the patent if the assignee names did not match.

Once determined, the Assurance Score is then transmitted to Assurance Ranking Comparator 270 where Assurance Ranking Comparator 270 compares the Assurance Score to an established Assurance Ranking Scale to generate an Assurance Ranking. In this embodiment, the Assurance Ranking Scale may be based upon risk parameters established by various sectors of the industry, such as, for example, by insurance companies, valuation professionals, financial lenders, investors and the like.

For example, in one embodiment, an insurance company may establish an Assurance Ranking Scale of Assurance Scores ranging from 1 (lowest score) to 10 (highest score) which may be assigned by Assurance Score Analyzer 260 depending upon the accuracy and/or reliability of the assignee data as generated by Data Reliability Analyzer 240. Under the Assurance Ranking Scale of this example, the insurance company has established that an Assurance Score of between 8 and 10 will be considered insurable at the most favorable premium rate, an Assurance Score of between 5 and 7 will be considered insurable at a higher premium rate, and an Assurance Score of below 5 will be considered uninsurable. In this embodiment, the Assurance Ranking and associated report transmitted to User Interface 210 may comprise the Assurance Score, the insurable/uninsurable designation, and/or the insurance premium rate.

Similar Assurance Ranking Scales may be utilized in System 200 which comprise one or more Assurance Ranking Scales associated with intangible property valuation, licensing royalties, financial lending decisions, intellectual property and representations and warranties insurance, and/or other vehicles requiring risk assessment.

In addition, Data Reliability Analyzer 240 of the instant invention may utilize one or more objective risk assessment methodologies to increase the reliability, accuracy, and completeness of the data received from Search Engine 220. For example, the title insurance embodiment of System 200 described above (in addition to employing the data comparison and verification methodology), may also utilize, through Data Reliability Analyzer 240, a second data reliability analysis which also employs one or more of the “known risk factor” (as described below), Monte Carlo simulation, and/or linear programming methodologies. Accordingly, utilization of additional objective risk factor methodologies is intended to increase the reliability of the risk factor analysis being conducted.

The “known risk factor” methodology utilizes known risks which are inherent in the data being analyzed. For example, it may be known that 2% of the patents contained in the United States Patent and Trademark Office issued patent database contain errors or omissions in the assignee identified on the face of the issued patent. It may also be known that 6% of the assignee data contained in the United States Patent and Trademark Office assignments database contain errors or omissions in the assignee identified as the current owner of the patent. In addition, it may also be known that, on average, 4% of patent assignments which have been executed are not recorded in the United States Patent and Trademark Office assignments database.

Based upon these known risk factors, the Assurance Score generated by Assurance Score Analyzer 260 may be adjusted to account for the increased risk that the information obtained from the various United States Patent and Trademark Office databases may contain errors or omissions. Accordingly, the Assurance Score assessed by Assurance Ranking Comparator 270 may be reduced as a result of the increased risk introduced by the known errors and omissions contained in the various databases.

Similarly, Monte Carlo simulation methodologies may also be utilized when assessing various risks with System 200. System 200 may employ any Monte Carlo simulated modeling, including, but not limited to, those which employ normal, lognormal, uniform, triangular, PERT, discrete and/or other probability distributions which may be appropriate for the risk assessment being performed.

In addition, Systems 200 may be configured to assess the risk associated with the validity of, or the ability to enforce, rights in intangible property such as patents, trademarks and copyrights. Moreover, Systems 200 may be configured to assess the risk associated with valuation of intangibles such as, for example asset value or licensing royalty rates.

Furthermore, risk analysis data accumulated and/or generated by System 200, may be retained by System 200 in one or more Databases 200, or in databases external to System 200. Such historical data may be utilized in assessing the risk of intangible assets. For example, such historical data may be utilized to create and/or otherwise establish the parameters, algorithms, protocols and/or rules which are relevant to the analysis of the accuracy of the data being analyzed by System 200. In addition, such historical data may be automatically fed back into risk assessment models such as Monte Carlo simulations.

Various reports also may be generated from data and other information input, output, stored, generated, or otherwise utilized by System 200. For example, reports summarizing the risk assessment conducted through System 200 including the data and queries entered into System 200, the intangible analyzed, the risk assessment methodologies employed, the sources of data accessed and/or relied upon, the parameters, algorithms, protocols and/or rules utilized the assumptions and limitations imposed, and any other information relevant to the assessment of risk conducted through System 200.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the appended claims and the equivalents thereof.

What is claimed is:

1. A system for assessing risk associated with intangible property, said system comprising:
a search engine comprising a processor which receives a search request from a user interface, searches for, and retrieves from said database data and other information related to said risk assessment of said property; and
an assurance ranking generator comprising a processor which utilizes objective assessment criteria to determine accuracies and inaccuracies in said data and other information, and generates an assurance ranking associated with said property being assessed for said risk;
wherein said user interface may provide access to said system through which descriptive information concerning the intangible asset to be assessed for risk, and the nature of the risk assessment to be performed may be input into said system; and
wherein said database provides access to said data and other information related to said risk assessment of said property.

2. The system of claim 1, wherein said assurance ranking generator further comprises:
a data reliability analyzer which assesses the accuracy of said data and information;
an assurance score analyzer which assigns an assurance score to said property; and
an assurance ranking comparator which compares said assurance score against an assurance ranking scale to generate said assurance ranking associated with said property.

3. The system of claim 1, wherein said assurance ranking generator comprises one or more risk assessment analysis models to determine a likelihood of error in said data and information being analyzed, selected from the group comprising one or more of: data comparison and verification, known risk factor analysis, Monte Carlo numerical analysis, and linear programming methodologies.

4. The system of claim 2, wherein said data reliability analyzer comprises one or more risk assessment analysis models to determine a likelihood of error in said data and information being analyzed, selected from the group comprising one or more of: data comparison and verification, known risk factor analysis, Monte Carlo numerical analysis, and linear programming methodologies.

5. The system of claim 2, wherein said assurance score may be generated using one or more of preset parameters, algorithms, protocols, and rules which are related to said property.

6. The system of claim 2, wherein said assurance ranking scale may be based upon one or more of property valuation, licensing royalty rates, insurance premium rates, loan rates, and past and present litigation.

7. The system of claim 1, further comprising:
a system administration interface.

8. The system of claim 1, wherein said system operates approximately in real-time.

9. The system of claim 1, further comprising:
a reactive computing system.

10. The system of claim 1, wherein said database may comprise one or more databases which may contain one or more types of data chosen from one or more of: chain of title information; security interests; releases, or other liens against the property; historical risk analyses conducted by said system or elsewhere; parameters, algorithms, protocols and/or rules which are relevant to the analysis of the property being analyzed; pending litigation, reexaminations, reissues, post grant proceedings, trademark oppositions and cancellations; and/or other adversarial proceedings involving the intangible property being analyzed.

11. The system of claim 1, wherein said database may comprise one or more databases which may comprise one or more of: the United States Patent and Trademark Office databases; foreign patent office databases; foreign trademark office databases; United States federal databases; United States state databases; United States local government databases; UCC filing databases; foreign government databases; public document databases; non-public document databases; United States federal court databases; United States federal administrative agency databases; United States state court databases; United States state administrative agency databases; foreign court databases; foreign administrative agency databases; technology databases; business databases; databases containing information relevant to said property.

12. The system of claim 1, wherein said search request may comprise one or more requests to: identify one or more past or current owners of said property; identify one or more licensors or licensees of said property; generate a report of a chain of title of said property; generate a report of security interests against said property; generate a report of liens recorded against said property; generate a report of releases of security interests against said property; generate a report of releases of liens against said property; generate a report of pending litigation directly or indirectly associated with said property, reexaminations, reissues, post grant proceedings, trademark oppositions and cancellations, or other adversarial proceedings involving said property; and provide a risk assessment analysis of said search.

13. A system for developing risk assessment models for use with assessing risk associated with valuation, insurability, or collateralization of intangible assets, said system comprising:
a processor having an input for receiving predetermined parameters, selected from a group comprising algorithms, protocols, and rules which are relevant to analyzing data and other information accuracy associated with said asset being analyzed; wherein said processor may be programmed:
(i) to execute a predetermined software program to implement risk assessment analysis models selected from the group comprising: data comparison and verification, known risk factor analysis, Monte Carlo numerical analysis, and linear programming methodologies to determine a likelihood of error in said data and other information being analyzed;
(ii) to generate an assurance score based upon said likelihood of error in said data and other information being analyzed; and
(iii) to generate an assurance ranking based upon a comparison of said assurance score against a predetermined assurance ranking scale.

14. The system of claim 13, wherein said assurance ranking may be generated by an assurance ranking generator comprising:
a data reliability analyzer which assesses said data and information accuracy;
an assurance score analyzer which assigns an assurance score to said property; and an assurance ranking comparator which compares said assurance score against an assurance ranking scale to generate said assurance ranking associated with said property.

15. The system of claim 13, wherein said assurance ranking may be generated by one or more risk assessment analysis models to determine said likelihood of error in said data and information being analyzed, selected from the group comprising one or more of: data comparison and verification, known risk factor analysis, Monte Carlo numerical analysis, and linear programming methodologies.

16. The system of claim 14, wherein said data reliability analyzer comprises one or more risk assessment analysis models to determine said go to sleep go to sleep likelihood of error in said data and information being analyzed, selected from the group comprising one or more of: data comparison and verification, known risk factor analysis, Monte Carlo numerical analysis, and linear programming methodologies.

17. A method for developing risk assessment models for use with assessing risk associated with valuation, insurability, or collateralization of intangible assets, said method comprising the steps of:
providing a processor having an input for receiving predetermined parameters, selected from a group comprising algorithms, protocols, and rules relevant to analyzing data and other information accuracy associated with said asset being analyzed;
executing a predetermined software program in said processor which implements risk assessment analysis models selected from a group comprising: data comparison and verification, known risk factor analysis, Monte Carlo numerical analysis, and linear programming methodologies to determine a likelihood of error in said data and other information being analyzed;
generating an assurance score based upon said likelihood of error in said data and other information being analyzed; and
generating an assurance ranking based upon a comparison of said assurance score against a predetermined assurance ranking scale.

18. The method of claim 17, wherein said assurance ranking may be generated by a method comprising the steps of:
assessing said data and information for accuracy;
assigning an assurance score to said property; and an assurance ranking comparator which compares said assurance score against an assurance ranking scale to generate said assurance ranking associated with said property.

19. The method of claim 17, wherein said assurance ranking may be generated by one or more risk assessment analysis models to determine said likelihood of error in said data and information being analyzed, selected from the group comprising one or more of: data comparison and verification, known risk factor analysis, Monte Carlo numerical analysis, and linear programming methodologies.

20. The method of claim 18, wherein said step of assessing said data and information for accuracy further comprises one or more risk assessment analysis models to determine said likelihood of error in said data and information being analyzed, selected from the group comprising one or more of: data comparison and verification, known risk factor analysis, Monte Carlo numerical analysis, and linear programming methodologies.
